(19) United States
(12) Patent Application Publication
(10) Pub. No.: US 2010/0166438 A1
(43) Pub. Date: Jul. 1, 2010

(54) OPTICAL INTERFEROMETER AND OPTICAL RECEIVER

(75) Inventor: Takashi Shiraishi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/636,977

(22) Filed: Dec. 14, 2009

(30) Foreign Application Priority Data
Dec. 26, 2008 (JP) 2008-332023

(51) Int. Cl. H04B 10/06; G02B 6/28; G02B 27/10

(52) U.S. Cl. 398/208; 385/24; 359/578

(57) ABSTRACT

An optical interferometer includes a substrate; a first and a second branch lines; a third and a fourth branch lines; a first interference portion for causing the first and the third branch lights to interfere with each other; and a second interference portion for causing the second and the fourth branch lights to interfere with each other; wherein each of the first and the third branch lines runs in the surface of the substrate such that the first and the third branch lines provide respective optical path lengths with a constant difference for a temperature change, and each of the second and the fourth branch lines runs in the surface such that the second and the fourth branch lines provide respective optical path lengths with a constant difference for a temperature change.

### CROSS-REFERENCE TO RELATED APPLICATION

This application is based upon and claims the benefit of priority of the prior Japanese Patent Application No. 2008-332023, filed on Dec. 26, 2008, the entire contents of which are incorporated herein by reference.

### FIELD

The embodiments discussed herein are related to an optical interferometer and an optical receiver.

### BACKGROUND

Recently, high speed communication has been realized in the optical communication technology. In the present situation, transition from a 10-Gb/s transmission system to a 40-Gb/s transmission system is on-going. In the future, development of an optical transmitter and optical receiver for the 40-Gb/s or 100-Gb/s system will be important.

In the past, an intensity modulation using binary data “1” and “0” has been employed in the optical communication. However, in the optical communication at 40 Gb/s or higher, a multilevel modulation is considered to expand transmission capacity. As the multilevel modulation, a phase modulation such as BPSK (Binary Phase Shift Keying) or QPSK (Quadrature Phase Shift Keying) has gained recognition.

FIG. 1A is a diagram illustrating a modulating wave of an optical output in the intensity modulation and FIG. 1B is a diagram illustrating a phase state. In FIG. 1A, the lateral axis indicates time and the vertical axis indicates optical output intensity. As illustrated in FIG. 1A, the presence of the wave represents ON (binary one) and the absence of the wave represents OFF (binary zero), and the binary data are transmitted in time order.

In FIG. 1B, a component of the same phase (I: In-Phase) is indicated on the real axis, while a component whose phase is shifted by 90 degrees (Q: Quadrature-Phase) is indicated on the imaginary axis. As described in FIG. 1B, in the case of a basic intensity modulation, an electric field of optical output has only the I component. As a result, the phase is not shifted.

FIG. 2A is a diagram illustrating the modulating wave of the optical output by the QPSK modulation, and FIG. 2B is a diagram illustrating a phase state. In the basic QPSK modulation, the optical intensity is not changed with time but the phase is changed. As described in FIG. 2B, the phase of an optical signal in the QPSK modulation has four values. That is, the QPSK modulation is a multilevel phase-modulation.

If an optical signal modulated by the intensity modulation as illustrated in FIGS. 1A and 1B is to be received, ON/OFF of the optical signal is converted into ON/OFF of an electric signal using a PD (photodiode). However, if an optical signal modulated by the phase modulation as illustrated in FIGS. 2A and 2B is to be received, the signal is not correctly received by a PD alone.

As a useful method for receiving a phase modulated signal, a coherent receiving method is disclosed in “Phase- and Polarization-Diversity Coherent Optical Techniques,” Kazovosky, L. G., JOURNAL OF LIGHTWAVE TECHNOLOGY, VOL 7, NO. 2, p. 279, 1989. The coherent receiving method, which is based on interference between a signal light (S) and a local-oscillator light (L), is a method to estimate a phase of the signal light with respect to that of the local-oscillator light.

FIG. 3 is a diagram illustrating a configuration of a basic coherent receiver. The signal light and the local-oscillator light interfere with a same phase (S+L) at an interferometer called “90° hybrid” and also interfere with phases having a phase difference of 90° (S+jL). If outputs of the 90° hybrid are received by the respective detectors, supposing that the phase difference between the signal light and the local-oscillator light is Φ(t), components of cos Φ(t) and sin Φ(t) are detected by the detector. As a result, by electrically processing a detected signal by a signal processor, the phase of the signal light can be estimated.

FIG. 4 is a diagram illustrating a configuration of another coherent receiver. The 90° hybrid outputs a positive phase (S+L) and a negative phase (S−L) and also a positive phase (S+jL) and a negative phase (S−jL) with the phase shifted by 90°. These outputs are received by two Balanced PDs, respectively. Photocurrent from each balanced PD is converted to a voltage by a TIA (trans-impedance amplifier) and then, converted to a digital signal by an ADC (Analog to Digital Converter) and the signal is processed. This method is more favorable than that illustrated in FIG. 3 in a point that S/N rate can be improved.

In this type of coherent receiving method, it is important to have the signal light and the local-oscillator light interfere with each other accurately in the same phase or with a phase difference of 90°, and characteristic improvement of the 90° hybrid is indispensable.

As examples of the 90° hybrid, 90° hybrids having a space optical system are disclosed in U.S. Laid-open Patent Publication No. 2007/0223932 and “Compact Bulk Optical 90° Hybrid for Balanced Phase Diversity Receivers,” Langenhorst, R., et al., Electronics Letters, Vol. 25, p 1518, 1989. Furthermore, 90° hybrids having a waveguide are disclosed in “Polarization Insensitive MZI-based DQPSK Demodulator with Asymmetric Half-wave Plate Configuration,” Nasu, Y., et al., OFC (Optical Fiber Telecommunication) 2008, OThE5, 2008 and “High-Speed InP DQPSK Receiver” Doerr, C. R., et al., OFC 2008, PDP23, 2008. The waveguide device is capable of size reduction as compared with the space type and has an advantage in that PDs can be integrated into the waveguide device.

An example of the 90° hybrids constituted by a PLC waveguide is also disclosed in “Polarization Insensitive MZI-based DQPSK Demodulator with Asymmetric Half-wave Plate Configuration.” In this example, the 90° phase difference is generated using a heater. A 90° hybrid using an InP waveguide is disclosed in “High-Speed InP DQPSK Receiver.” In this type, interference and output are carried out at the same time by 2×4 star coupler.

On the other hand, U.S.Laid-open Patent Publication No. 2004/0096143 describes a 90° hybrid using a LiNbO₃ waveguide. In this technique, phase adjustment by 90° is carried out using an electro-optical effect by voltage application. These waveguide-type 90° hybrids have a disadvantage that the phase is easily fluctuated in accordance with an ambient environment such as temperature change. In particular, when a photoelastic material such as LiNbO₃ is used for a substrate, the fluctuation of phase caused by temperature change is large.

“Integrated Optics Eight-Port 90° Hybrid on LiNbO₃” Hoffmann, D., et al., JOURNAL OF LIGHTWAVE TECHNOLOGY VOL. 7, No. 5, P794, 1989 describes that the phase of the 90° hybrid using the LiNbO₃ waveguide shifts 15°/1° C. In this case, since the phase is largely shifted by temperature change, the device needs strict control of the phase. Also, its cost of manufacture is high, and a device size is large.

With the techniques disclosed in the above documents, it is difficult to realize a 90° hybrid having satisfactory phase stability against temperature drift.

The present invention was made in view of the above difficulties and has an object to provide an optical interferometer and an optical receiver that can realize satisfactory phase stability against temperature drift.

### SUMMARY

According to an aspect of the invention, an optical interferometer for receiving a first and a second input light and for outputting a first and a second output lights, includes a substrate; a first branch portion formed on the substrate for branching the first input light into a first and a second branch lights; a first and a second branch lines formed on the substrate for transmitting the first and the second branch lights, respectively; a second branch portion formed on the substrate for branching the second input light into a third and a forth branch lights; a third and a fourth branch lines formed on the substrate for transmitting the third and the fourth branch lights, respectively; a first interference portion formed on the substrate and connected to the first and the third branch lines for receiving the first and third branch lights, causing the first and the third branch lights to interfere with each other, and outputting a first output light; and a second interference portion formed on the substrate and connected to the second and the fourth branch lines for receiving the second and fourth branch lights, causing the second and the fourth branch lights to interfere with each other, and outputting a second output light; wherein each of the first and the third branch lines runs in the surface of the substrate such that the first and the third branch lines provide respective optical path lengths with a constant difference for a temperature change, and each of the second and the fourth branch lines runs in the surface such that the second and the fourth branch lines provide respective optical path lengths with a constant difference for a temperature change.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating a modulating wave of an optical output in an intensity modulation, and FIG. 1B is a diagram illustrating a phase state;

FIG. 2A is a diagram illustrating a modulating wave of an optical output in a QPSK modulation, and FIG. 2B is a diagram illustrating a phase state;

FIG. 3 is a diagram illustrating a configuration diagram of a simple coherent receiver;

FIG. 4 is a diagram illustrating a configuration diagram of another coherent receiver;

FIG. 5 is a diagram illustrating a top view of an optical interferometer according to a first embodiment;

FIG. 6 is a diagram illustrating arrangement of a balanced receiver;

FIG. 7 is a diagram illustrating a structure of a 90° hybrid according to a comparative example;

FIG. 8 is a diagram illustrating a case in which a phase difference caused by a temperature change occurs;

FIG. 9 is a diagram illustrating a variation of the first embodiment;

FIGS. 10A to 10C are diagrams illustrating a case in which a first interference portion and a second interference portion are considered separately;

FIG. 11 is a diagram illustrating an integrated amount of a strain;

FIG. 12A is a diagram illustrating a case in which an interference portion is displaced from a center axis, and FIGS. 12B and 12C are diagrams illustrating an integrated amount of a strain;

FIG. 13 is a diagram illustrating a third embodiment;

FIGS. 14A and 14B are diagrams illustrating a fourth embodiment;

FIG. 15 is a diagram illustrating a fifth embodiment; and

FIGS. 16A to 16D are diagrams illustrating experiments result.

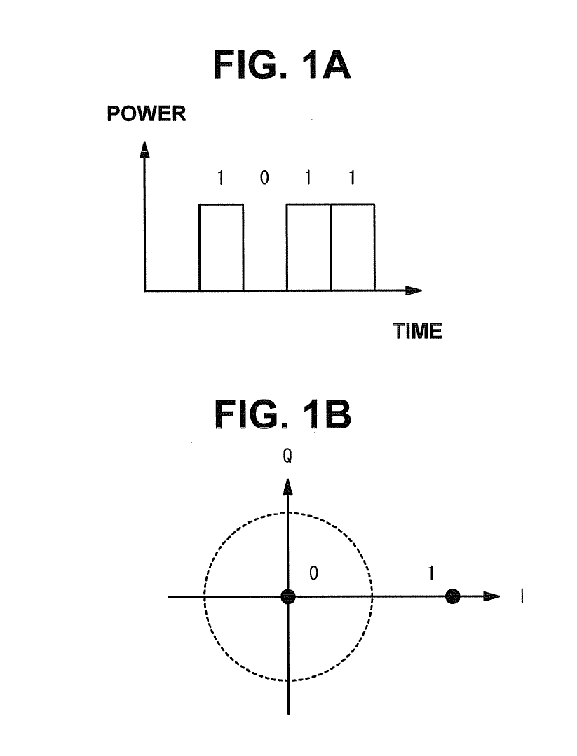

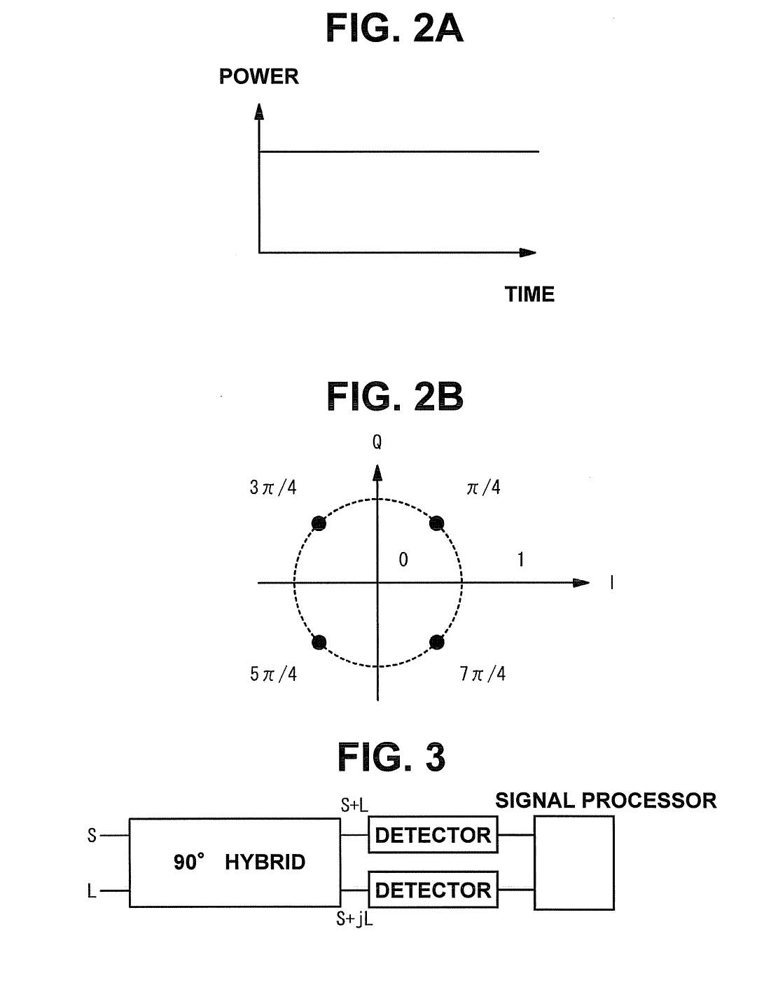

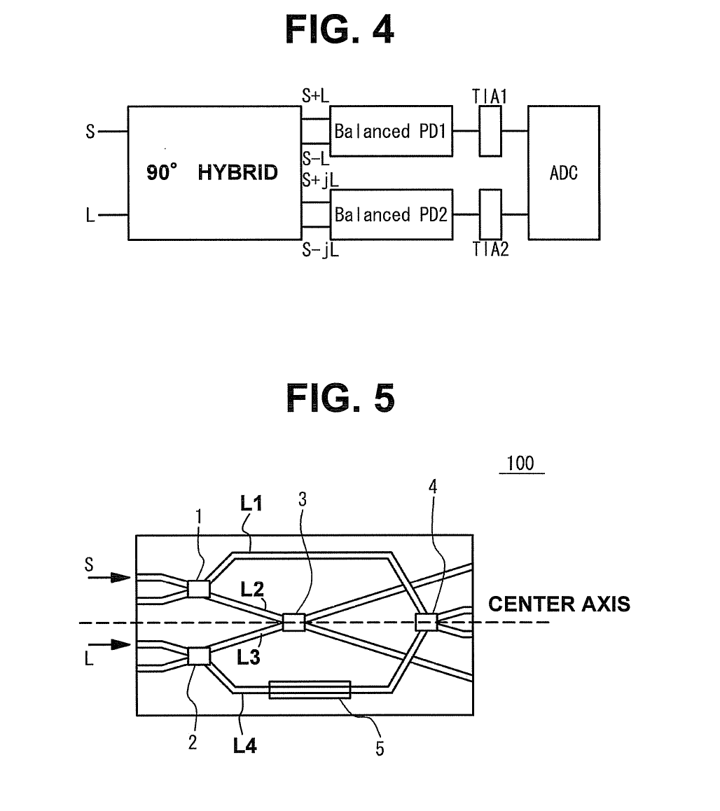

### DESCRIPTION OF EMBODIMENTS

Embodiments will be described below referring to the attached drawings.

### First Embodiment

FIG. 5 is a top view for explaining an optical interferometer 100 according to a first embodiment. In the optical interferometer 100, a signal light (S) is equally distributed by a 3 dB-coupler 1 (splitter), while a local-oscillator light (L) is equally distributed by a 3 dB-coupler 2 (splitter). The signal light outputted from the 3 dB-coupler 1 to a lower side in the figure and the local-oscillator light outputted from the 3 dB-coupler 2 to an upper side in the figure interfere with each other in the same phase at a 3 dB-coupler 3 (first interference portion). A branch line L2 from the 3 dB-coupler 1 to the 3 dB-coupler 3 and a branch line L3 from the 3 dB-coupler 2 to the 3 dB-coupler 3 are hereinafter referred to as a first branch line portion.

Also, the local-oscillator light outputted from the 3 dB-coupler 2 to a lower side in the figure has its phase shifted by 90° with respect to the signal light outputted from the 3 dB-coupler 1 to an upper side in the figure at a 90° phase adjustment portion 5. After that, the local-oscillator light outputted from the 3 dB-coupler 2 to the lower side in the figure and the signal light outputted from the 3 dB-coupler 1 to the upper side in the figure interfere with each other at a 3 dB-coupler 4 (second interference portion) with the phases shifted by 90°. A branch line L1 from the 3 dB-coupler 1 to the 3 dB-coupler 4 and a branch line L4 from the 3 dB-coupler 2 to the 3 dB-coupler 3 are hereinafter referred to as a second branch line portion.

The 3 dB-coupler 3 and the 3 dB-coupler 4 are arranged on the center axis of a chip substrate. Two waveguides constituting the first branch line portion have equal waveguide lengths and have a symmetric structure to the center axis of the chip substrate. Also, two waveguides constituting the second branch line portion also have equal waveguide lengths and have a symmetric structure to the center axis of the chip substrate.

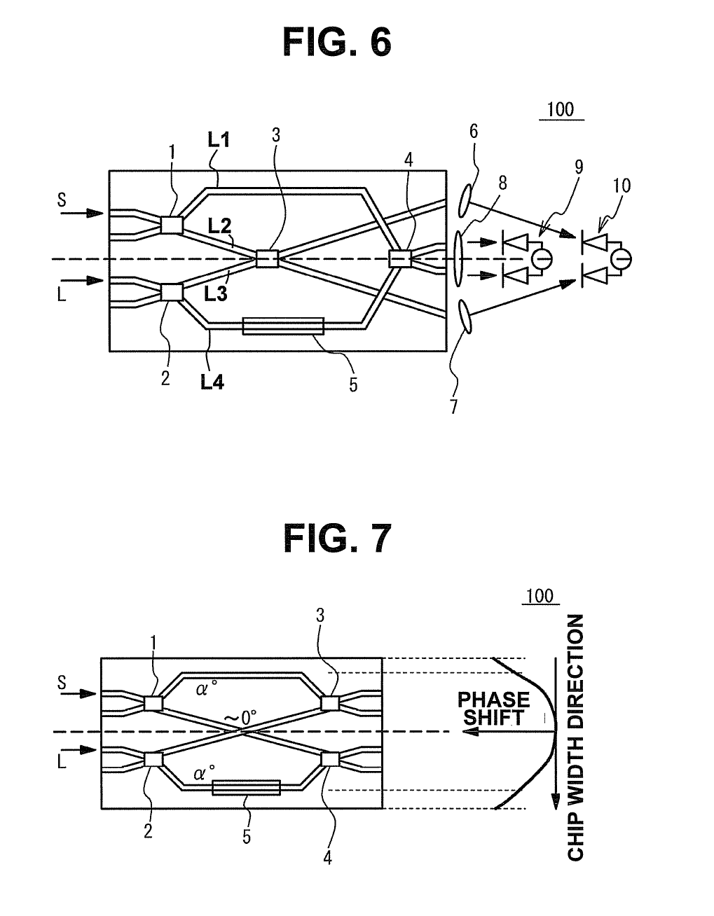

As will be explained in FIG. 6, the output from the first branch line portion crosses the waveguide of the second branch line portion and is outputted to the outside, passes through lenses 6, 7 and the like and is collected by a balanced receiver 10. The output from the first branch line portion and the waveguide of the second branch line portion preferably cross each other at such an angle that crosstalk is not caused. Each of the light path lengths from the first branch line portion to the balanced receiver 10 is set so as to be equal to each other.

The output from the second branch line portion is outputted to the outside, passes through the lens 8 or the like and is collected by a balanced receiver 9. Each of the light path lengths from the second branch line portion to the balanced receiver 9 is set so as to be equal to each other. The 90° phase shift is realized in the waveguide according to a waveguide length difference, temperature, stress, voltage and the like. Also, the phase shift realized by the temperature, stress and voltage can be actively controlled.

Subsequently, an operation principle of this embodiment will be described. FIG. 7 is a diagram illustrating a structure of a 90° hybrid according to a comparative example. In the comparative example, the signal light is equally distributed by the 3 dB-coupler 1, and the local-oscillator light is equally distributed by the 3 dB-coupler 2. The signal light outputted from the 3 dB-coupler 1 to an upper side in the figure and the local-oscillator light outputted from the 3 dB-couler 2 to an upper side in the figure interfere with each other in the same phase at the 3 dB-coupler 3 (first interference portion). Also, the local-oscillator light outputted from the 3 dB-coupler 2 to a lower side in the figure has its phase shifted by 90° to the signal light outputted from the 3 dB-coupler 1 to the lower side in the figure at the 90° phase adjustment portion 5. As a result, the signal light outputted from the 3 dB-coupler 1 to the lower side in the figure and the local-oscillator light outputted from the 3 dB-copuler 2 to the lower side in the figure interfere with each other at the 3 dB-coupler 4 in a state in which the phases are shifted by 90° (second interference portion).

In such a structure, the respective interferometers are not made symmetric to the center axis of the chip substrate. Here, to the chip substrate, heat strain depending on a temperature is applied, caused by adhesion stress with a housing, stress from a film forming portion on the chip substrate and the like. For example, the whole surface of the chip substrate is fixed on the housing by an adhesive. This heat strain is generally symmetric to the center axis of the chip substrate. In the substrate having a photoelastic effect such as LiNbO₃, its refraction index is changed if strain is applied. Therefore, if the temperature is changed, the phase differences of the respective interferometers are changed. For example, if a phase shift α° is generated by a temperature as in FIG. 7, the phase difference at the first interference portion is changed from 0° to α°, and the phase difference at the second interference portion is changed from 90° to 90+α°. In this case, a normal receiving operation is not executed.

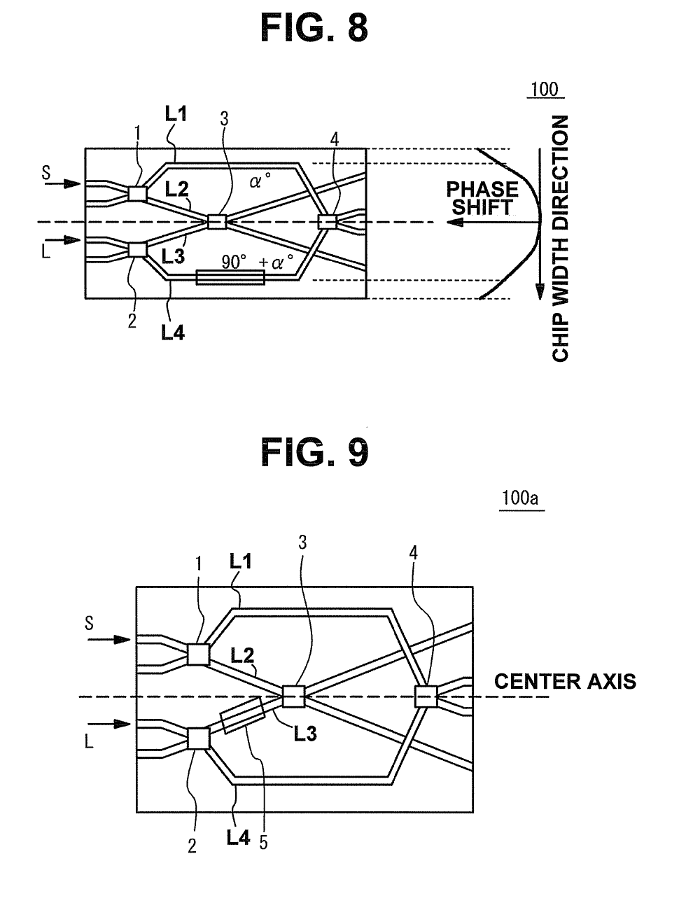

On the other hand, in the structure according to this embodiment, since the respective interferometers are symmetric to the center axis, even if the phase shift by the temperature change is generated as illustrated in FIG. 8, the phase difference of 0° can be maintained at the first interference portion, and the phase difference of 90° can be maintained at the second interference portion. The chip substrate has varying thermal expansion properties along the surface. The thermal expansion property is the property that the surface of the chip substrate strains along the surface against temperature change because the chip substrate is formed on another substrate such as the housing and/or the film is formed on the chip substrate, the thermal expansion coefficient of the material of the chip substrate being different from that of the another substrate and the film. When the branch lines L2 and L3 are arranged symmetrically with each other with respect to the center line of the chip substrate along the direction parallel to the direction along which the branch lines L2 and L3 extend generally, each of the branch lines L2 and L3 runs in the surface having the same thermal expansion property for the same optical path lengths as the other such that the branch lines L2 and L3 provide respective optical path lengths with a constant difference for a temperature change. When the branch lines L1 and L4 are arranged symmetrically with each other with respect to the center line of the chip substrate along the direction parallel to the direction along which the branch lines L1 and L4 extend generally, each of the branch lines L1 and L4 runs in the surface having the same strain amounts for the same optical path lengths as the other such that the branch lines L1 and L4 provide respective optical path lengths with a constant difference for a temperature change. In the chip substrate having a photoelastic effect, its refraction index is changed if strain is applied. However, even if the temperature is changed, the phase differences at the first and the second interference portions are not changed respectively. As a result, a stability of the phase difference against the temperature can be realized. Moreover, a 90° hybrid having a stability of the phase difference against temperature can be realized. As a result, active control of the phase is no longer needed, and even if the active control of the phase is needed, a voltage for the control can be made small.

(Variation)

FIG. 9 is a diagram illustrating an optical interferometer 100a according to a variation of the first embodiment. In this variation, the 90° phase adjustment portion 5 is provided in one of the waveguides constituting the first interference portion. That is, the 90° phase adjustment portion 5 is provided inside the chip substrate. Therefore, in this variation, interference of the 90° phase is performed in the first interference portion and interference of the 0° phase is performed in the second interference portion. In this variation, too, since the respective interferometers are symmetric to the center axis of the chip substrate, even if the phase shift caused by the temperature change is generated, the phase difference of 0° can be maintained at the first interference portion, and the phase difference of 90° can be maintained at the second interference portion.

In FIG. 9, the 90° phase adjustment portion 5 is provided in the optical waveguide from the 3 dB-coupler 2 to the 3 dB-coupler 3, but the same effect can be also obtained if it is provided in the optical waveguide from the 3 dB-coupler 1 to the 3 dB-coupler 3.

### Second Embodiment

In the first embodiment, the branch lines constituting the respective interferometers are symmetric to the center axis. However, if a temperature change amount of the refraction index applied to each of the two branch lines constituting the respective interferometers is made equal, the stability of the pahse difference against temperature can be obtained. That is, it is preferable that an integrated amount of the strain applied to each of the branch lines is made equal along a direction where light travels.

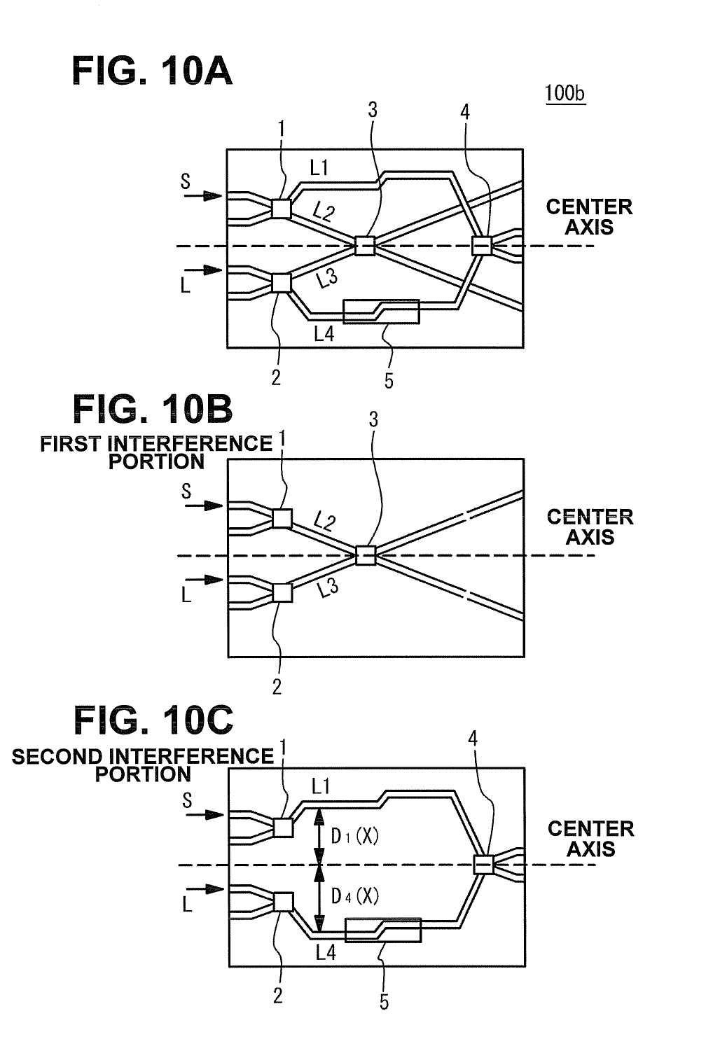

In an optical interferometer 100b according to this embodiment, as will be described in FIGS. 10A to 10C, when it is considered separately for the first interference portion and the second interference portion, an integrated amount in the direction of the center axis of a strain applied to the branch line constituting each of the interference portions is made equal. Since the strain becomes symmetric to the chip center axis, it does not have to be apparently symmetric to the center axis as the second interference portion in FIG. 10C, for example.

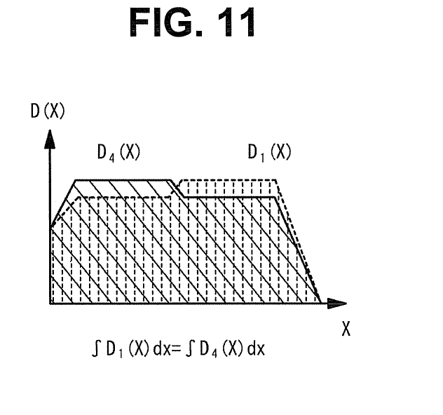

The second interference portion in FIG. 10C is examined as an example. A branch line on an upper side of the figure constituting the second interference portion is set as a branch line L1, and a branch line on a lower side of the figure is set as a branch line L4. Also, based on the center axis, when a direction along the center axis is set as the X direction, and distances of the branch lines L1 and L4 from the center axis are set as D1(X) and D4(X), it is preferable that the following equation (1) is satisfied (FIG. 11):

∫D1(X)dX=∫D4(X)dX (1)

Also, it is preferable to make the waveguide length of the branch line L1 and the waveguide length of the branch line L4 equal to each other at the same time. Similarly, in the first interference portion in FIG. 10B, a branch line on the upper side in the figure is set as a branch line L2, and a branch line on the lower side in the figure is set as a branch line L3. The branch lines L2 and L3 are set so that the following equation (2) is satisfied if distances of the branch lines L2 and L3 from the center axis are set as D2(X) and D3(X):

∫D2(X)dX=∫D3(X)dX (2)

In this embodiment, too, by setting the branch lines L1 to L4 so that the equation (1) and the equation (2) are satisfied, the phase difference of 0° at the first interference portion can be maintained even if the phase shift is caused by a temperature change, and the phase difference of 90° at the second interference portion can be maintained even if the phase shift is caused by a temperature change.

(Variation)

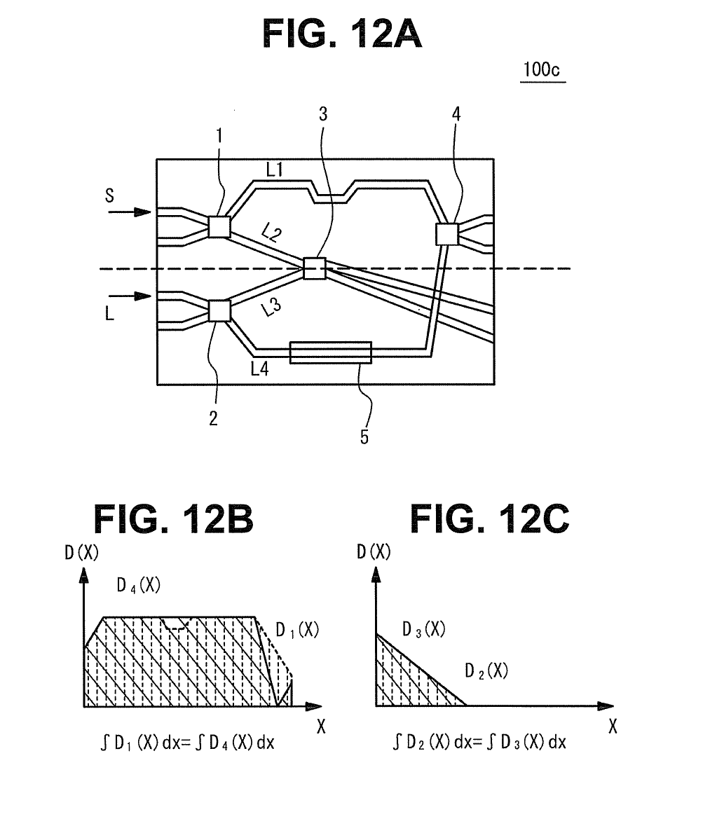

The 3 dB-coupler of each of the interference portions is arranged on the chip center axis in each of the above embodiments, but not limited to that. For example, as will be described in FIG. 12A, the interference portion may be arranged with displacement from the center axis as with an optical interferometer 100c according to this variation. In this case, too, by setting so that the integrated amount in the center axis direction of the strain applied to the branch lines constituting each of the interference portions as FIGS. 12B and 12C, the stability of the phase difference against temperature can be obtained.

However, in this case, since it is preferable to know how a size of the strain is distributed in the substrate in a stage of designing, the distribution needs to be checked in advance by experiments. Also, in order to make the strains of the first interference portion and the second interference portion equal at the same time, complicated design is appropriate. On the other hand, by arranging each of the interference portions on the center axis, the strains can be made symmetric with a simple design.

### Third Embodiment

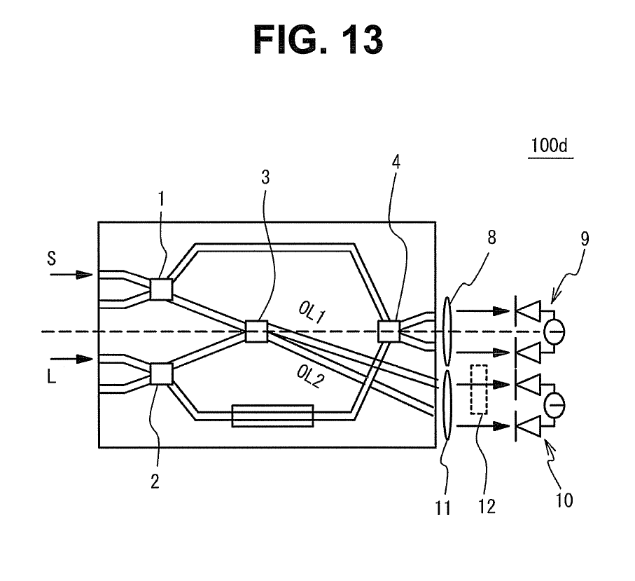

FIG. 13 is a diagram illustrating an optical interferometer 100d according to a third embodiment. As having been described in FIG. 6, an optical path length from interference to an input in the PD needs to be made equal. With the arrangement in FIG. 6, it is easy to make the output line from the interference to the input in the PD equal, but arrangement becomes difficult if a balanced receiver is used.

On the other hand, with the structure described in FIG. 13, by setting the optical waveguides from the first interference portion as output lines OL1 and OL2 and by making the lengths of the output lines OL1 and OL2 equal in the substrate, the balanced receiver can be integrated more easily. If the lengths of the output lines are not made equal in the substrate, it is possible to give an optical path length difference to a line from output to the outside of the substrate and to the input into the PD so as to make the lengths equal. In this case, the difference may be given simply to a length of the line, or an optical path length adjustment portion may be provided using a general optical compensator 12 such as a wavelength plate.

### Fourth Embodiment

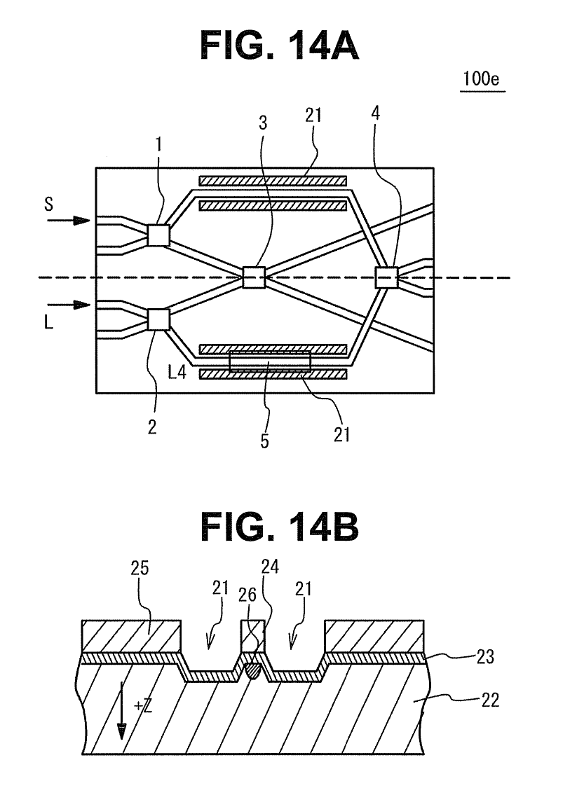

FIGS. 14A and 14B are diagrams for explaining an optical interferometer 100e according to a fourth embodiment. FIG. 14A is a top view of the optical interferometer 100e and FIG. 14B is a sectional view on the branch line L4 of the optical interferometer 100e. In the case of 90° phase adjustment by a voltage, a Z-cut LiNbO₃ plate may be used as a chip substrate 22. Also, in this case, an electrode 24 for voltage application may be arranged above an optical waveguide 26 and grounding electrodes 25 on both sides thereof. In this case, by applying a voltage to the electrode 24 for voltage application, a refraction index can be changed. The optical waveguide 26 can be formed by diffusing Ti over the LiNbO₃ plate.

Between the optical waveguide 26 and the electrode 24 for voltage application, a buffer layer 23 made of SiO₂ or the like is generally provided in order to avoid absorption loss of light. By digging a ridge groove 21 beside the optical waveguide 26, electric-field application efficiency to the optical waveguide 26 can be improved, and a voltage for phase adjustment can be reduced.

For the ridge waveguide in which a groove is formed beside the waveguide, too, the stability of the phase difference against temperature can be obtained. Also, since distribution of strain is changed by formation of the ridge groove 21 in the case as in FIGS. 14A and 14B, a symmetric structure is preferably provided by also forming a similar groove on the branch line side to which a voltage is not to be applied.

### Fifth Embodiment

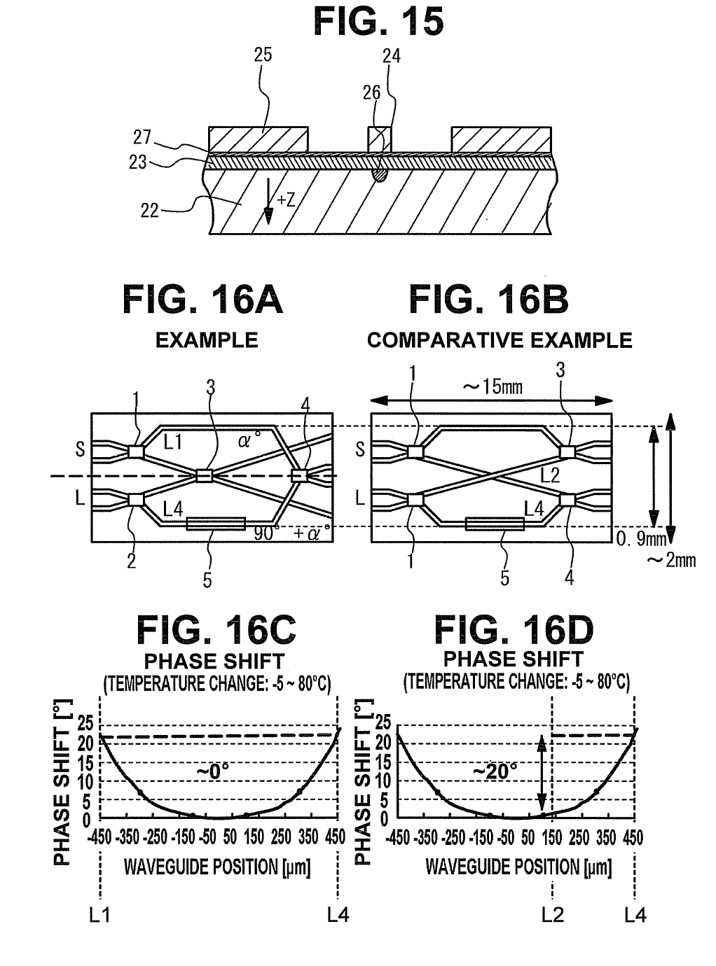

FIG. 15 is a diagram illustrating a fifth embodiment. In each of the above embodiments, the structures to deal with phase changes by strain have been explained. However, in the substrate with pyroelectricity such as LiNbO₃, an electric charge is generated by a temperature change. In this case, uneven distribution of the generated charges causes an uneven electric field on the substrate, and a phase change occurs. In order to improve such temperature characteristics caused by pyroelectricity, in the case of an optical modulator using a LiNbO₃ substrate, for example, a semi-conductive film may be formed on a buffer layer disclosed in Japanese Examined Patent Application Publication No. 5-78016 (Japanese Laid-open Patent Publication No. 62-073027) in order to make the charges by pyroelectricity equal.

As in the structure described in FIG. 15, by forming the buffer layer 23 on the optical waveguide 26 and by forming a semi-insulating film 27 on the buffer layer 23, an optical interferometer and a 90° hybrid with more excellent stability of the phase difference against temperature can be provided. The semi-insulating film 27 is preferably Si or the like formed by a sputtering process or the like.

In each of the above embodiments, the waveguide lengths of the two branch lines constituting each of the interference portions are equal, but not limited to that. For example, by giving a waveguide length difference, the phase may be adjusted by temperature, pressure, voltage and the like.

### EXAMPLES

FIGS. 16A to 16D are diagrams illustrating experiments result. In an example, the optical interferometer 100 according to the first embodiment is manufactured, and a phase shift by temperature is calculated from experiment data. Dimensions of the optical interferometer are general sizes as in FIGS. 16A and 16B. The chip substrate is a LiNbO₃ substrate. As illustrated in FIGS. 16C and 16D, when the phase shift in a temperature change from −5 to 80° C. is estimated, it is confirmed that phase fluctuation of approximately 20° is generated in the configuration of the comparative example, while it is substantially suppressed to 0° in the example. In this way, it is confirmed that since a change amount of the refraction index by temperature in each branch line is made equal, stability of the phase difference against temperature can be obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

Moreover, on the basis of the description of the above embodiments, configurations illustrated below can be considered:

An optical interferometer including:

a first branch portion which branches input light to at least first branch light and second branch light;

a second branch portion which branches input light to at least third branch light and fourth branch light;

a first interference portion having said first branch light and said third branch light interfere with each other; and

a second interference portion having said second branch light and said fourth branch light interfere with each other, wherein

an optical waveguide length difference between two branch lines each constituting said first interference portion and an optical waveguide length difference between two branch lines constituting said second interference portion are constant to a temperature change in each branch line.

An optical interferometer comprising:

a substrate;

first, second, third and fourth optical waveguides formed on the substrate, respectively;

a first splitter that branches first input light to at least first branch light traveling through the first waveguide and second branch light traveling through the second waveguide;

a second splitter that branches second input light to at least third branch light traveling through the third waveguide and fourth branch light traveling through the fourth waveguide;

a first interference combiner inputting the first branched light and the third branched light to interfere with each other at a first phase; and

a second interference combiner inputting the second branched light and the fourth branched light to interfere with each other at a second phase, wherein

the first phase at the first interference combiner and the second phase at the second interference combiner are constant to a temperature change in each waveguide.

According to the optical interferometer and the optical receiver disclosed in the specification, satisfactory stability of the phase difference against temperature drift can be realized.

What is claimed is:

1. An optical interferometer for receiving a first and a second input light and for outputting a first and a second output lights, comprising:
a substrate;
a first branch portion formed on the substrate for branching the first input light into a first and a second branch lights;
a first and a second branch lines formed on the substrate for transmitting the first and the second branch lights, respectively;
a second branch portion formed on the substrate for branching the second input light into a third and a forth branch lights;
a third and a fourth branch lines formed on the substrate for transmitting the third and the fourth branch lights, respectively;
a first interference portion formed on the substrate and connected to the first and the third branch lines for receiving the first and third branch lights, causing the first and the third branch lights to interfere with each other, and outputting a first output light; and
a second interference portion formed on the substrate and connected to the second and the fourth branch lines for receiving the second and fourth branch lights, causing the second and the fourth branch lights to interfere with each other, and outputting a second output light;
wherein each of the first and the third branch lines runs in the surface of the substrate such that the first and the third branch lines provide respective optical path lengths with a constant difference for a temperature change, and each of the second and the fourth branch lines runs in the surface of the substrate such that the second and the fourth branch lines provide respective optical path lengths with a constant difference for a temperature change.

2. An optical interferometer according to claim 1, wherein the substrate has varying thermal expansion properties along the surface areas, each of the first and the third branch lines runs in the surface areas having the same thermal expansion properties for the same optical path lengths as the other, and each of the second and the fourth branch lines runs in the surface areas having the same thermal expansion properties for the same optical path lengths as the other.

3. The optical interferometer according to claim 2, wherein a first distance between the first branch line and the center axis, and a second distance between the third branch lines and the center axis satisfy the following equation (1):
∫D1(X)dX=∫D2(X)dX (1)
wherein a direction along the center axis is set as the X direction, D1(X) is the first distance, and D2(X) is the second distance; and a third distance between the second branch line and the center axis, and a fourth distance between the fourth branch lines and the center axis satisfy the following equation (2):
∫D3(X)dX=∫D4(X)dX (2)
wherein a direction along the center axis is set as the X direction, D3(X) is the third distance, and D4(X) is the fourth distance.

4. The optical interferometer according to claim 2, wherein the first and the second interference portion is arranged on the center axis of the substrate.

5. The optical interferometer according to claim 2, wherein the first, the second, the third and the fourth branch lines extends generally along one direction, the first and the third branch lines being arranged symmetrically with each other with respect to a center line of the substrate along the one direction, the second and the fourth branch lines being arranged symmetrically with each other with respect to the center line of the substrate.

6. The optical interferometer according to claim 2, wherein the first and the third branch lights interfere with each other in the same phase at the first interference portion, and the second and the fourth branch light interfere with each other in a phase shifted by 90° at the second interference portion.

7. The optical interferometer according to claim 2, wherein the phase shifted by 90° is generated in accordance with each length of the branch lines, each temperature of the branch lines, a stress added to at least one of the branch lines, or a voltage applied to at least one of the branch lines.

8. The optical interferometer according to claim 6, wherein the phase shifted by 90° is controlled by changing each temperature of the branch lines, a pressure added to at least one of the branch lines, or a voltage applied to at least one of the branch lines.

9. The optical interferometer according to claim 2, wherein the substrate having at least a groove beside at least one of the branch lines.

10. The optical interferometer according to claim 9, wherein the at least a groove is a plurality of grooves on both sides of the at least one of the branch lines, the grooves being formed symmetrically with respect to the at least one of the branch lines.

11. The optical interferometer according to claim 2, wherein the branch lines are waveguides formed by diffusing Ti on the substrate.

12. An optical receiver comprising:
an optical interferometer for receiving a first and a second input light and for outputting a first and a second output lights, including:
a substrate;
a first branch portion formed on the substrate for branching the first input light into a first and a second branch lights;
a first and a second branch lines formed on the substrate for transmitting the first and the second branch lights, respectively;
a second branch portion formed on the substrate for branching the second input light into a third and a forth branch lights;
a third and a fourth branch lines formed on the substrate for transmitting the third and the fourth branch lights, respectively;
a first interference portion formed on the substrate and connected to the first and the third branch lines for receiving the first and third branch lights, causing the first and the third branch lights to interfere with each other, and outputting a first output light; and
a second interference portion formed on the substrate and connected to the second and the fourth branch lines for receiving the second and fourth branch lights, causing the second and the fourth branch lights to interfere with each other, and outputting a second output light;
wherein each of the first and the third branch lines runs in the surface of the substrate such that the first and the third branch lines provide respective optical path lengths with a constant difference for a temperature change, and each of the second and the fourth branch lines runs in the surface of the substrate such that the second and the fourth branch lines provide respective optical path lengths with a constant difference for a temperature change;
a first balanced receiver for inputting the first output light; and
a second balanced receiver for inputting the second output light.

13. The optical receiver according to claim 12, wherein the substrate has varying thermal expansion properties along the surface areas, each of the first and the third branch lines runs in the surface areas having the same thermal expansion properties for the same optical path lengths as the other, and each of the second and the fourth branch lines runs in the surface areas having the same thermal expansion properties for the same optical path lengths as the other.

14. The optical receiver according to claim 12, wherein the first and the third branch lights interfere with each other in the same phase at the first interference portion, and the second and the fourth branch light interfere with each other in a phase shifted by 90° at the second interference portion.

15. The optical receiver according to claim 13, wherein the first output light is branched into a first output branch light and a second output branch light, the optical path length of the first output branch light from the first interference portion to the first balanced receiver being equal to that of the second output branch light from the first interference portion to the first balanced receiver, and the second output light is branched into a third output branch light and a fourth output branch light, the optical path length of the third output branch light from the second interference portion to the second balanced receiver being equal to that of the fourth output branch light from the second interference portion to the second balanced receiver.

16. The optical receiver according to claim 12, further comprising a wavelength plate through which one of the first output branch light and the second branch light passing, for adjusting the optical path length of the one of the first output branch light and the second output branch light.

17. The optical receiver according to claim 12, further comprising:
a first trans-impedance amplifier connected to the first balanced receiver, the first and the second output branch lights being converted to a first photocurrent by the first balanced receiver, the first photocurrent being converted to a first voltage by each trans-impedance amplifier;
a first Analog to Digital Converters connected to the first trans-impedance amplifier, for converting the first voltage to a first digital signal;
a second trans-impedance amplifier connected to the second balanced receiver, the third and the fourth output branch lights being converted to a second photocurrent by the second balanced receiver, the second photocurrent being converted to a second voltage by the trans-impedance amplifier; and
a second Analog to Digital Converters connected to the second trans-impedance amplifier, for converting the second voltage to a second digital signal.

18. The optical interferometer according to claim 12, wherein the substrate is made of LiNbO₃.

19. An optical interferometer comprising:
a substrate;
first, second, third and fourth optical waveguides formed on the substrate, respectively;
a first splitter that branches first input light to at least first branch light traveling through the first waveguide and second branch light traveling through the second waveguide;
a second splitter that branches second input light to at least third branch light traveling through the third waveguide and fourth branch light traveling through the fourth waveguide;
a first interference combiner inputting the first branched light and the third branched light to interfere with each other at a first phase; and
a second interference combiner inputting the second branched light and the fourth branched light to interfere with each other at a second phase, wherein
the first phase at the first interference combiner and the second phase at the second interference combiner are constant to a temperature change in each waveguide.
